(19) United States
(12) Patent Application Publication
(10) Pub. No.: US 2023/0236138 A1
(43) Pub. Date: Jul. 27, 2023

(54) RADIATION IMAGING APPARATUS AND RADIOGRAPHING SYSTEM

(71) Applicant: CANON KABUSHIKI KAISHA, Tokyo (JP)

(72) Inventors: TAKANORI TAYA, Kanagawa (JP); MISAKI KURIYAMA, Saitama (JP)

(21) Appl. No.: 18/157,627

(22) Filed: Jan. 20, 2023

(30) Foreign Application Priority Data
Jan. 26, 2022 (JP) 2022-010275
Dec. 14, 2022 (JP) 2022-199795

(51) Int. Cl. G01N 23/04

(52) U.S. Cl. CPC G01N 23/04; G01N 2223/313; G01N 2223/401

(57) ABSTRACT

A radiation imaging apparatus includes an attenuation member for reducing reflection of components arranged on a backside of the radiation imaging apparatus generated by back scattered radiation that has reflected on a structure on the backside of the radiation imaging apparatus, the attenuation member being provided on the backside of the radiation incident plane of the radiation detection unit, wherein the attenuation member is made of a material with a higher atomic number and a material with a lower atomic number than a material with a highest atomic number among materials of the component, covers an end portion of an outer shape of the component overlapping the radiation detection unit in orthogonal projection onto the second plane, and is smaller in area than the radiation detection unit.

### BACKGROUND OF THE INVENTION

### Field of the Invention

The present disclosure relates to a radiation imaging apparatus and radiographing system.

### Description of the Related Art

There is currently widespread use of radiation imaging apparatuses for radiographic medical image diagnosis and non-destructive inspection, in which a flat panel detector (hereinafter, abbreviated as FPD) formed of a semiconductor material is used as a radiation detector. These radiation imaging apparatuses are used in radiographing systems for medical image diagnosis, for example, as digital imaging apparatuses that are capable of still-image capturing such as plain imaging or moving-image capturing such as fluoroscopic imaging.

A radiation imaging apparatus generates a radiographic image by turning radiation from a radiation generation apparatus into an electric signal by an FPD arranged in the radiation imaging apparatus. At this time, a portion of the radiation passes through the FPD and then can become scattered radiation (back scattered radiation) by being reflected on a structure on the side of the FPD opposite to the side on which the radiation is incident and then entering the FPD again. Such back scattered radiation may enter the FPD through a component arranged on the side of the FPD opposite to the side on which the radiation is incident and the component may be reflected in the radiographic image to generate an artifact.

For example, Japanese Patent Application Laid-Open No. 2004-294114 discusses a technique for reducing the influence of an artifact by using attenuation members different in radiation transmittance in corresponding regions such that the amount of back scattered radiation reaching the FPD becomes almost uniform. An attenuation member is generally heavier in weight with a lower radiation transmittance. However, according to the technique discussed in Japanese Patent Application Laid-Open No. 2004-294114, attenuation members with high radiation transmittance, that is, with low-weight attenuation members are used in regions that do not affect the image quality, so that the radiation imaging apparatus can be made lightweight. Making a radiation imaging apparatus lighter in weight reduces the work load on the user who carries the radiation imaging apparatus for setting the radiation imaging apparatus with respect to a subject.

Nevertheless, in the technique discussed in Japanese Patent Application Laid-Open No. 2004-294114, it is necessary to use an attenuation member with low radiation transmittance, that is, a heavy-weight attenuation member at a position where a component with high radiation transmittance is arranged on the side of the FPD opposite to the side on which the radiation is incident. For example, if a component with low radiation transmittance is made lighter in weight for weight reduction of the radiation imaging apparatus, an attenuation member with low radiation transmittance is arranged in a region with high radiation transmittance. This causes a disadvantage that it is difficult to further reduce the weight of the radiation imaging apparatus.

### SUMMARY OF THE INVENTION

The present disclosure is made in view of the above-described disadvantage. An aspect of the present disclosure is to provide a technique for reducing an artifact that could occur in a radiographic image due to back scattered radiation while suppressing the weight of a radiation imaging apparatus.

According to an aspect of the present disclosure, a radiation imaging apparatus that performs radiographic imaging based on radiation having been emitted by a radiation generation apparatus and passed through a subject, includes a radiation detection unit that includes a plurality of pixels for converting the radiation into an electrical signal and has a first plane on a side of the radiation detection unit which the radiation from the radiation generation apparatus is incident and a second plane on a side opposite to the first plane, a component that is provided on the second plane of the radiation detection unit, and an attenuation member that is provided on the second plane of the radiation detection unit to attenuate back scattered radiation incident on the radiation detection unit from the side of the second plane, wherein the attenuation member is made of a material with a higher atomic number and a material with a lower atomic number than a material with a highest atomic number among materials of the component, covers an end portion of an outer shape of the component overlapping the radiation detection unit in orthogonal projection onto the second plane, and is smaller in area than the radiation detection unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a radiographing system according to a first exemplary embodiment.

FIGS. 2A and 2B are diagrams illustrating a configuration of a radiation imaging apparatus according to the first exemplary embodiment.

FIG. 3 is a schematic diagram illustrating back scattered radiation according to the first exemplary embodiment.

FIGS. 4A and 4B are schematic diagrams illustrating arrangement of an attenuation member according to the first exemplary embodiment.

FIGS. 5A and 5B are diagrams illustrating the relationship between the positions in FIG. 4 and the incident amounts of scattered radiation according to the first exemplary embodiment.

FIGS. 6A and 6B are schematic diagrams illustrating arrangement of an attenuation member according to a second exemplary embodiment.

### DESCRIPTION OF THE EMBODIMENTS

Hereinafter, exemplary embodiments to which the present disclosure is applied will be described in detail with reference to the accompanying drawings.

The following exemplary embodiments are not intended to limit the disclosure according to the claims. The exemplary embodiments include a plurality of features as described below. However, all of these features are not necessarily essential to the disclosure, and the features may be arbitrarily combined. In the accompanying drawings, identical or similar components are denoted with identical reference signs, and duplicated description thereof will be omitted. The term radiation here can typically refer to X rays but is not limited to X rays. For example, other radiations (for example, α rays, β rays, γ rays, and the like) are also applicable.

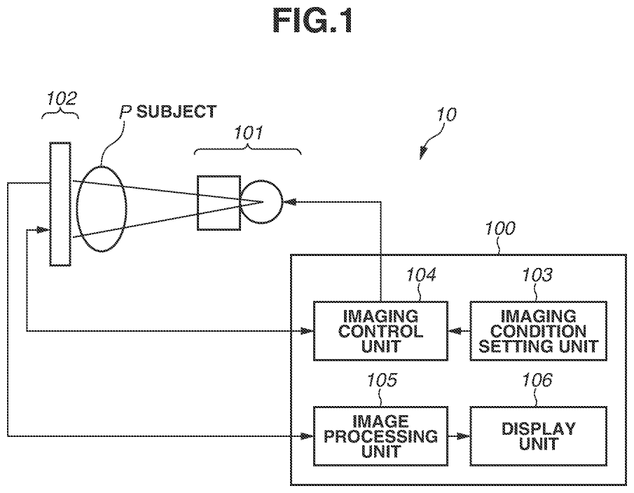

FIG. 1 is a diagram illustrating an overall configuration of a radiographing system 10 according to a first exemplary embodiment of the present disclosure. The radiographing system 10 includes a control apparatus 100, a radiation generation apparatus 101, and a radiation imaging apparatus 102. The control apparatus 100 includes an imaging condition setting unit 103, an imaging control unit 104, an image processing unit 105, and a display unit 106. The control apparatus 100 can be a general-purpose computer that includes a central processing unit (CPU), a main storage device, an auxiliary storage device, and a display, and implements functions of the components of the control apparatus 100.

The radiation generation apparatus 101 emits radiation to a subject P. The radiation generation apparatus 101 includes an X-ray tube that generates radiation, a collimator that defines the spread angle of beam of the generated radiation, and a radiation dosimeter that is attached to the collimator.

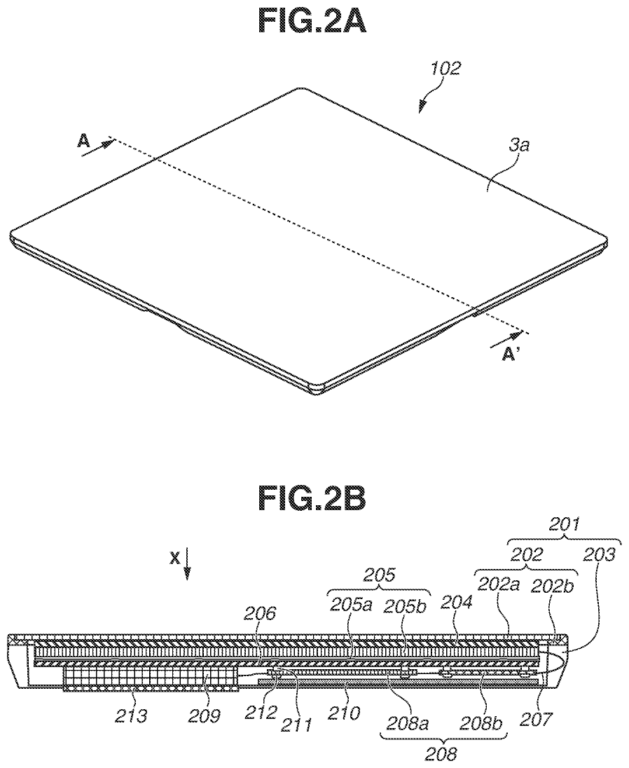

The radiation imaging apparatus 102 performs radiographic imaging based on the radiation having been emitted by the radiation generation apparatus 101 and passed through the subject P. Image data generated by the radiographic imaging is transmitted to the image processing unit 105 so that the image data undergoes various types of image processing to form a radiographic image. The radiation imaging apparatus 102 also transmits information on the detected dosage of radiation to the imaging control unit 104. The internal structure of the radiation imaging apparatus 102 will be described in detail with reference to FIG. 2.

The imaging condition setting unit 103 has an imaging condition input unit for the operator to input imaging conditions such as X-tube voltage, X-tube current, and an imaging target part. The imaging conditions input by the operator are transmitted to the imaging control unit 104. The imaging control unit 104 controls the radiation generation apparatus 101, the radiation imaging apparatus 102, and the image processing unit 105, based on the input imaging conditions.

The image processing unit 105 performs image processing such as offset correction, gain correction, and noise reduction, on the radiographic image transmitted from the radiation imaging apparatus 102. The image processing unit 105 transmits the radiographic image having undergone the image processing to the display unit 106. The display unit 106 is a general-purpose display or the like and outputs the image information transmitted from the image processing unit 105.

FIGS. 2A and 2B are diagrams illustrating a configuration of the radiation imaging apparatus 102 in the present exemplary embodiment. FIG. 2A is an external perspective view of the radiation imaging apparatus 102 as seen from the incident plane, and FIG. 2B is a cross-sectional view of the radiation imaging apparatus 102 taken along line A-A′ in FIG. 2A and seen from the direction indicated by the arrows. Arrow X in FIG. 2B schematically indicates the direction of the radiation incident on the radiation imaging apparatus 102.

The radiation imaging apparatus 102 is in the shape of a substantially rectangular parallelepiped, and a housing 201 contains components of the radiation imaging apparatus 102. The housing 201 includes a front cover 202 having a breastplate portion 202a and a frame portion 202b, a rear cover 203, and a cover 213 of a secondary battery 209.

The breastplate portion 202a is a plate-like member that is arranged on the side of the housing 201 on which radiation is incident. Since the radiation imaging apparatus 102 may be brought under a load when being used for image capturing, the breastplate portion 202a is preferably a high-stiffness member. In addition, since the breastplate portion 202a is located on the incident side of radiation from the radiation generation apparatus 101, the breastplate portion 202a is preferably made of a material with high radiation transmittance. From these viewpoints, the breastplate portion 202a is made of carbon fiber reinforced plastic (CFRP), for example. The frame portion 202b positioned at the peripheral edge of the breastplate portion 202a is made of a magnesium alloy.

The rear cover 203 is a plate-like member that is arranged on the side of the housing 201 opposite to the side on which radiation is incident. Since the radiation imaging apparatus 102 may be brought under a load as described above, the rear cover 203 is preferably a high-stiffness member. The rear cover 203 is also preferably made of a material with high radiation transmittance. From these viewpoints, the rear cover 203 is made of CFRP, for example.

In the housing 201, an impact absorption sheet 204, a radiation detection unit 205, and a base 206 are stacked in this order from the incident side of radiation. The impact absorption sheet 204 protects the radiation detection unit 205 from impact from the outside of the housing 201.

The radiation detection unit 205 is a flat panel detector (FPD) including a plurality of pixels 205a and a scintillator layer 205b on the plurality of pixels 205a. The plurality of pixels 205a each has photoelectric conversion elements and is aligned in a two-dimensional array on a substrate. The scintillator layer 205b is made of a plurality of crystals of scintillator that subjects radiation to wavelength conversion into light sensible by the photoelectric conversion elements. The radiation emitted from the radiation generation apparatus 101 is converted into light by the scintillator layer 205b, and is further converted into electric signals by the photoelectric conversion elements of the plurality of pixels 205a. The electrical signals from the plurality of pixels 205a are read by a drive circuit and a read circuit to generate a radiographic image.

The radiation detection unit 205 illustrated in FIG. 2B is configured such that the scintillator layer 205b and the plurality of pixels 205a are stacked in this order from the incident side of radiation, but the stacking order in this structure may be reversed. The following description is based on the case where, as illustrated in FIG. 2B, the radiation detection unit 205 is structured such that the scintillator layer 205b and the plurality of pixels 205a are stacked in this order from the incident side of radiation.

The plane on the side of the radiation detection unit 205 on which the radiation from the radiation generation apparatus 101 is incident will be called first plane, and the plane on the side opposite to the first plane will be called second plane. In the following description, the plane on the side on which the plurality of pixels 205a is provided is the first plane, and the plane opposed to the first plane is the second plane.

The radiation detection unit 205 is connected to a control board 208 via a flexible circuit board 207. The control board 208 has the drive circuit and the read circuit described above, and controls drive signals and the like for reading signals from the photoelectric conversion elements.

The base 206 is a plate-like member for supporting the radiation detection unit 205. The radiation detection unit 205 is arranged on the side of the base 206 on which radiation is incident. The control board 208, the secondary battery 209, and wireless modules and antenna units not illustrated are provided on the side of the base 206 opposite to the side on which radiation is incident, and these components are supported by the base 206. The control board 208 (208a, 208b) is fixed to the base 206, for example, by a fixing member (e.g. a bolt) 212. Concave and convex portions (steps) for supporting the various components may be formed by a spacer 211 on the side of the base 206 opposite to the side on which radiation is incident. The base 206 is preferably made of a magnesium alloy, taking into consideration securing of stiffness, weight reduction, and avoidance of influence of electrical noise.

The secondary battery 209 supplies electrical power for driving. The wireless modules and antenna portions function as wireless communication units that wirelessly transmit image signals to external apparatuses.

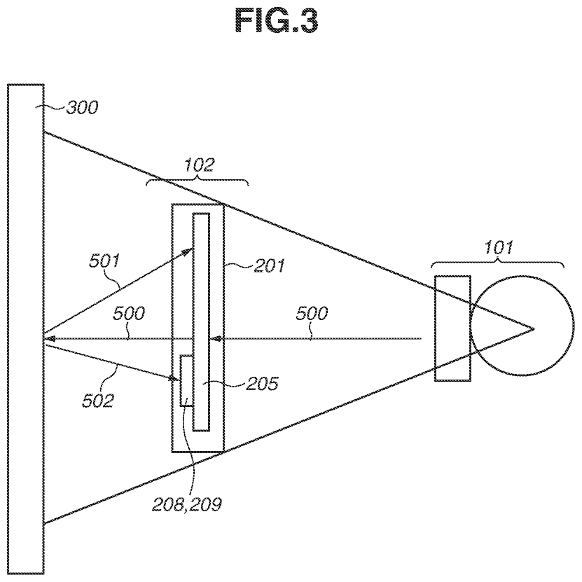

An attenuation member 210 is provided to attenuate back scattered radiation incident on the radiation detection unit 205. The back scattered radiation is a constituent of radiation emitted to the radiation detection unit 205. If a portion of the radiation passes through the radiation detection unit 205 or the irradiation field is wider than the radiation detection unit 205, the back scattered radiation is reflected on a structure on the side of the radiation detection unit 205 opposite to the side on which the radiation was incident, and enters the radiation detection unit 205 again. The back scattered radiation will be described in detail with reference to FIG. 3. The attenuation member 210 is made of a material that absorbs radiation, such as tungsten, molybdenum, lead, stainless used steel (SUS), iron, bismuth, or cerium, for example.

Since the attenuation member 210 is a member that attenuates back scattered radiation incident on the radiation detection unit 205, the attenuation member 210 is provided on the second plane of the radiation detection unit 205. For example, the attenuation member 210 is provided between the radiation detection unit 205 and the base 206, inside and outside the rear cover 203 of the housing 201. However, the position of the attenuation member 210 is not limited to this and is sufficient as long as the attenuation member is provided on the second plane of the radiation detection unit 205.

Next, back scattered radiation will be described with reference to FIG. 3. FIG. 3 is a diagram illustrating the state of back scattered radiation in the radiation generation apparatus 101 and the radiation imaging apparatus 102. The radiation 500 emitted from the radiation generation apparatus 101 enters the radiation detection unit 205 arranged inside the radiation imaging apparatus 102.

A portion of the radiation 500 incident on the radiation detection unit 205 passes through the radiation detection unit 205 without being absorbed by the scintillator layer 205b of the radiation detection unit 205, and is reflected and scattered on structures 300 such as the wall surface on the rear side of the radiation detection unit 205 and the floor, and enters the radiation detection unit 205 again from the rear side. If radiation is emitted in a wider range than the radiation detection unit 205, the radiation is similarly reflected and scattered on structures 300 such as the wall surface on the rear side of the radiation imaging apparatus 102 and the floor, and then enters again the radiation detection unit 205 from the rear side.

The back scattered radiation incident from the rear side may be partially attenuated by components of the radiation imaging apparatus 102 arranged on the rear side (501) or may partially enter a phosphor (502). The difference in the radiation transmittance between the place with a component and the place without a component causes the reflection of the component, that is, the occurrence of an artifact in the radiographic image. Energy E′ of the back scattered radiation is determined by Compton scattering expressed by the following equation 1:

$${E}^{′} = \frac{E}{1 + \frac{E}{511} ( 1 - cos θ )} \qquad [ Equation 1 ]$$

In the equation, E is energy [keV] of the incident radiation, E′ is energy [keV] of the radiation having undergone Compton scattering, and θ is the angle formed by the incident direction of the radiation and the scattering direction of the Compton-scattered radiation. The back scattered radiation refers to the radiation that has undergone Compton scattering in a range of 90°≤θ≤180°.

If the attenuation member 210 is provided so as to shield the entire surface of the radiation detection unit 205 from back scattered radiation, the absolute amount of the back scattered radiation incident on the radiation detection unit 205 can be decreased, thereby to reduce an artifact. However, providing the attenuation member 210 on the entire surface of the radiation detection unit 205 increases the weight of the radiation imaging apparatus 102. The radiation imaging apparatus 102 needs to be made as lightweight as possible because the radiation imaging apparatus 102 is often carried by the user for setting with respect to a subject.

In the present disclosure, an attenuation member smaller in area than the radiation detection unit 205 is arranged to reduce an artifact due to the reflection of a component resulting from back scattered radiation outside the housing of the radiation imaging apparatus 102 while making the radiation imaging apparatus 102 lightweight.

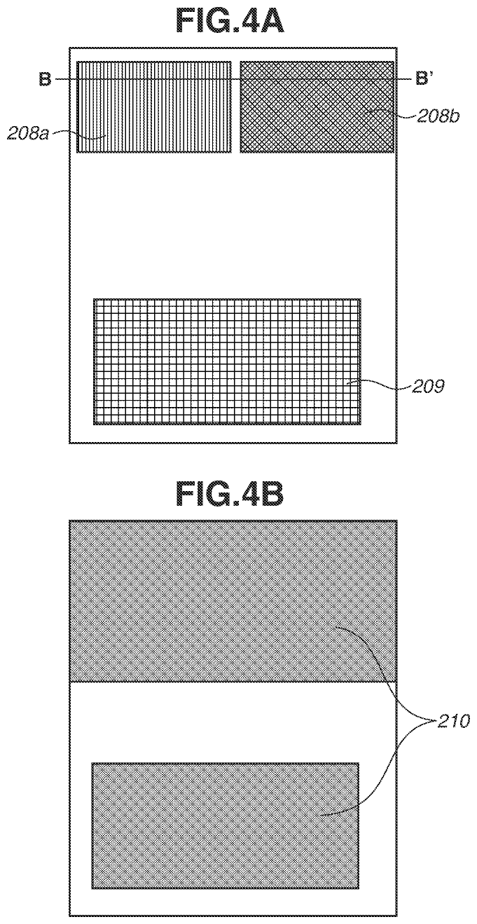

FIGS. 4A and 4B are diagrams simply illustrating a configuration of the radiation imaging apparatus 102 in the present exemplary embodiment. FIG. 4A is a diagram illustrating the radiation imaging apparatus 102 without an attenuation member, as seen from the side opposite to the incident side of the radiation imaging apparatus 102 (arrow X in FIG. 2), and FIG. 4B is a diagram illustrating the radiation imaging apparatus 102 with an attenuation member. The radiation imaging apparatus 102 illustrated in FIGS. 4A and 4B is provided with a control board 208a, a control board 208b, and a secondary battery 209.

In this configuration, there occurs a large difference in the amount of back scattered radiation incident on the second plane of the radiation detection unit 205 in the in-plane direction between the ends of outer shapes of these components and the places without the components. An artifact may appear in the places in the image with a large difference in the amount of back scattered radiation.

In the present exemplary embodiment, the attenuation member 210 is provided so as to cover the ends of the outer shapes of the components provided on the second plane of the radiation detection unit 205 where the reflection is to be reduced, in orthogonal projection onto the second plane of the radiation detection unit 205. The attenuation member 210 is higher in the radiation transmittance than the components the reflection of which is to be reduced.

In this manner, it is possible to moderate the difference in the amount of back scattered radiation reaching the second plane of the radiation detection unit 205, between the ends of outer shapes of the components the reflection of which is to be reduced and the places without the components, thereby reducing the occurrence of an artifact.

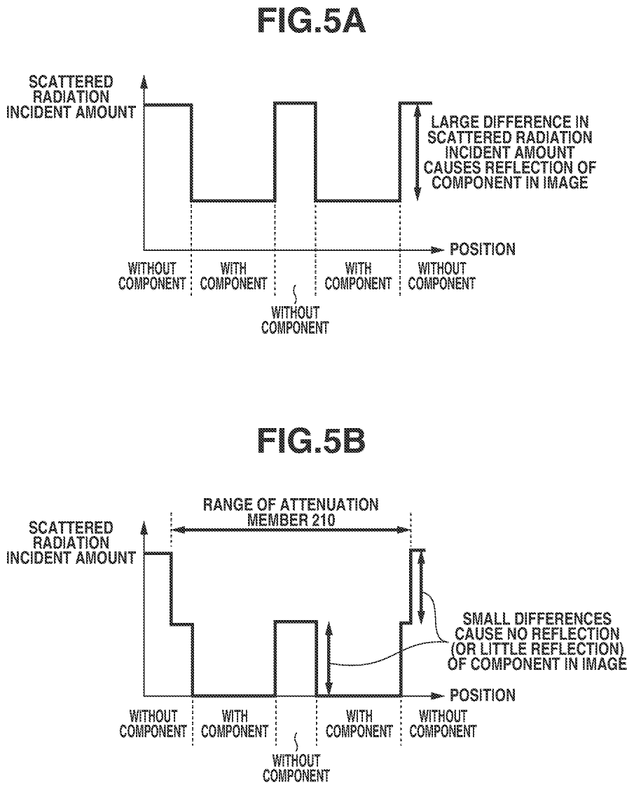

Hereinafter, description will be provided with reference to FIGS. 4A, 4B, 5A, and 5B. FIGS. 5A and 5B are diagrams illustrating the incident amounts of scattered radiation to the radiation detection unit 205 at positions taken along line B-B′ in FIG. 4. In the radiation imaging apparatus 102 illustrated in FIG. 4A, there are regions where components (the control board 208a and the control board 208b in FIG. 4A) at the positions taken along line B-B′ are provided and regions where no components are provided, on the side of the radiation detection unit 205 opposite to the side on which the radiation is incident. FIGS. 5A and 5B illustrate the incident amounts of scattered radiation in the individual regions.

FIG. 5A corresponds to a case where the attenuation member 210 is not provided as illustrated in FIG. 4A, and FIG. 5B corresponds to a case where the attenuation member 210 is provided as illustrated in FIG. 4B. In the case of FIG. 5A, there occurs a large difference in the incident amount of scattered radiation between the region with no components and the region with the components, so that the components may be reflected to cause an artifact.

On the other hand, in the case of FIG. 5B where the attenuation member 210 is provided, the attenuation member 210 creates a region covered with the components and the attenuation member 210, a region covered only with the attenuation member 210, and a region not covered with the components or the attenuation member 210.

The difference in the incident amount of scattered radiation among the regions illustrated in FIG. 5B is smaller than the difference between the region without the components and the region with the components in the case where the attenuation member 210 is not arranged, so that the components are unlikely to be reflected in the image, thereby reducing an artifact.

The attenuation member 210 is higher in the radiation transmittance than the components the reflection of which is to be reduced. This is because if the attenuation member 210 is lower in the radiation transmittance than the components the reflection of which is to be reduced, the attenuation member 210 will be reflected in the image.

Referring to FIGS. 4A and 4B, the attenuation member 210 is arranged so as to cover the control board 208a, the control board 208b, and the secondary battery 209. As described above with reference to FIG. 5, the difference in the amount of back scattered radiation between these regions is more moderate than that in the case without the attenuation member 210, so that the components are unlikely to be reflected in the image, thereby reducing an artifact.

Next, the radiation transmittance of the attenuation member 210 will be described in detail, particularly focusing on energy of X rays.

In general, the interactions between X rays carrying no electrical charge and a substance include photoelectric absorption, Compton scattering, and electron pair production. The dominant interaction attenuating X rays is photoelectric effect. The photoelectric effect becomes conspicuous with a higher-atomic-number substance. There is known an approximate expression of wide radiation energy and the atomic number of a substance as in the following equation 2:

$$τ ≅ constant \times x = \frac{{Z}^{n}}{{E}^{3.5}} \qquad [ Equation 2 ]$$

In the equation, τ denotes the probability of occurrence of photoelectric effect, E denotes the energy of radiation, and Z denotes the atomic number of the substance. It is known that an index n changes between 4 and 5 depending on the range of E. According to the equation 2, the radiation transmittance becomes lower as the atomic number Z of the substance constituting the attenuation member 210 is higher, which makes it possible to reduce the absolute amount of back scattered radiation incident on the radiation detection unit 205.

On the other hand, if the substance constituting the attenuation member 210 is higher in the atomic number Z than the substance constituting a component, the attenuation member 210 is lower in the radiation transmittance than the component.

In this case, as illustrated in FIG. 5B, there occurs a larger difference in the incident amount of scattered radiation between the region covered with only the attenuation member 210 and the region not covered with the components or the attenuation member 210 than that in the component, which may cause an artifact. In order to prevent the occurrence of such an artifact, it is desired to mix a substance with a higher radiation transmittance than the components, that is, a low-atomic-number substance into the attenuation member 210.

In particular, it is desired to decrease the radiation transmittance in the energy band of the back scattered radiation described in the equation 1 to be lower than that of the components. This makes it possible to moderate the difference in the amount of back scattered radiation among the regions as illustrated in FIG. 5B, thereby reducing the occurrence of an artifact.

In the attenuation member 210, out of the energy of the radiation emitted from the radiation generation apparatus 101, the ratio of radiation transmittance between a constituent of an energy band higher than the energy of back scattered radiation and a constituent of the energy band of the back scattered radiation is preferably lower than the ratio of radiation transmittance in the component.

For example, in general X-ray imaging, the maximum value of energy of emitted radiation is within a range of 100 kV to 140 kV. The maximum value of energy of back scattered radiation expressed by the equation 1 is within a range of about 70 kV to 90 kV. In this case, with 80 kV as the boundary, the attenuation member 210 is preferably higher than the components in the transmittance of radiation with energy of 80 kV or less, and the attenuation member 210 is preferably lower than the components in the transmittance of radiation with energy higher than 80 kV. Specifically, the attenuation member 210 is preferably formed by mixing a substance with a higher atomic number and a substance with a lower atomic number than the components the inflection of which is to be prevented.

In the foregoing description with reference to FIG. 4B, the components the reflection of which is to be reduced are the control board 208 and the secondary battery 209. However, the present disclosure is not limited to this. For example, the attenuation member 210 may be provided so as to cover concave and convex portions on the base 206, a communication antenna for the radiation imaging apparatus 102, cables for connection with various electric components, the ends portions of outer shapes of fastening members for fastening various components.

There may be a difference in the radiation transmittance between constituent parts of a component. For example, the secondary battery 209 includes a plurality of battery cells in the exterior, and there is a difference in the radiation transmittance between the exterior and battery cells of the secondary battery 209. In this case, the attenuation member 210 may be provided so as to cover the end portions of the constituent parts of the component. The material for the attenuation member 210 in this case can be formed of a substance with a higher atomic number and a substance with a lower atomic number than the constituent parts the reflection of which is to be prevented.

For example, in order to reduce the reflection of the control board 208, the main cause of the reflection is copper (Cu with atomic number 29). Thus, the attenuation member 210 is preferably formed of a substance with an atomic number higher than 29 and a substance with an atomic number lower than 29. In another example, the attenuation member 210 may be formed of a substance with a higher atomic number and a substance with a lower atomic number than iron used for fastening members (Fe with atomic number 26). The present disclosure is not limited to these examples. The material for the attenuation member 210 may be decided in accordance with the substance the influence of which is to be reduced.

The attenuation member 210 may be continuously changed in thickness at the end portion of the outer shape. This decreases the difference in the amount of back scattered radiation reaching the second plane of the radiation detection unit 205 at the end portion of the attenuation member 210, so that the outer shape of the attenuation member 210 is unlikely to be reflected in the radiographic image.

The attenuation member 210 may be detachably attached to the radiation imaging apparatus 102.

This facilitates the arrangement of the attenuation member 210 at an appropriate position, in view of the state of reflection in the actually captured radiographic image. Detachably attaching the attenuation member 210 facilitates the change of materials for the attenuation member 210 in accordance with the state of the reflection in the radiographic image.

Next, a second exemplary embodiment of the present disclosure will be described. The second exemplary embodiment is different from the first exemplary embodiment in that an attenuation member 210 covers only the end portions of components the reflection of which is to be reduced, not the entire components.

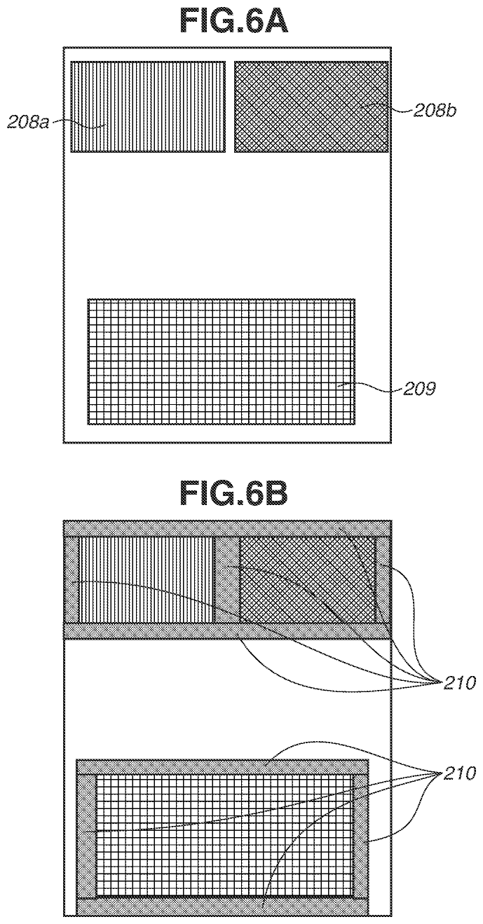

FIGS. 6A and 6B are schematic diagrams illustrating a radiation imaging apparatus 102 according to the present exemplary embodiment. FIG. 6A illustrates the radiation imaging apparatus 102 without an attenuation member, as seen from the side opposite to the incident side, and FIG. 6B illustrates the radiation imaging apparatus 102 to which the attenuation member 210 is added.

In the present exemplary embodiment, the radiation imaging apparatus 102 is provided with a control board 208a, a control board 208b, and a secondary battery 209, as components the reflection of which is to be reduced, and the attenuation member 210 is arranged at the outer end portions of these components. Arranging the attenuation member 210 as illustrated in FIG. 6 reduces the area of the attenuation member 210 to be smaller than that in the first exemplary embodiment, thereby further reducing the weight of the radiation imaging apparatus 102.

According to at least one exemplary embodiment of the present disclosure, it is possible to provide a radiation imaging apparatus that reduces an artifact resulting from back scattered radiation while suppressing the weight increase of the radiation imaging apparatus.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2022-010275, filed Jan. 26, 2022, and No. 2022-199795, filed Dec. 14, 2022, which are hereby incorporated by reference herein in their entirety.

What is claimed is:

1. A radiation imaging apparatus that performs radiographic imaging based on radiation having been emitted by a radiation generation apparatus and passed through a subject, comprising:
a radiation detection unit that includes a plurality of pixels for converting the radiation into an electrical signal and has a first plane on a side of the radiation detection unit which the radiation from the radiation generation apparatus is incident and a second plane on a side opposite to the first plane;
a component that is provided on the second plane of the radiation detection unit; and
an attenuation member that is provided on the second plane of the radiation detection unit to attenuate back scattered radiation incident on the radiation detection unit from the side of the second plane,
wherein the attenuation member is made of a material with a higher atomic number and a material with a lower atomic number than a material with a highest atomic number among materials of the component, covers an end portion of an outer shape of the component overlapping the radiation detection unit in orthogonal projection onto the second plane, and is smaller in area than the radiation detection unit.

2. The radiation imaging apparatus according to claim 1, wherein in the attenuation member, out of energy of the radiation emitted from the radiation generation apparatus, a ratio of radiation transmittance between a constituent of an energy band higher than energy of the back scattered radiation and a constituent of the energy band of the back scattered radiation is lower than a ratio of radiation transmittance in the component.

3. The radiation imaging apparatus according to claim 1, wherein the attenuation member is higher than the component in transmittance of radiation with energy of 80 kV or less, and the attenuation member is lower than the component in the transmittance of radiation with energy higher than 80 kV.

4. The radiation imaging apparatus according to claim 1, wherein the component is a control board for reading a signal from the radiation detection unit.

5. The radiation imaging apparatus according to claim 1, wherein the component is a secondary battery that supplies electric power to the radiation imaging apparatus.

6. The radiation imaging apparatus according to claim 1, wherein the component is an antenna for the radiation imaging apparatus to communicate with an external apparatus.

7. The radiation imaging apparatus according to claim 1, wherein the component is a base that supports the radiation detection unit on the side of the second plane of the radiation detection unit.

8. The radiation imaging apparatus according to claim 1, wherein the component is a fastening member that fastens a component of the radiation imaging apparatus.

9. The radiation imaging apparatus according to claim 1, wherein the component is a cable connected to a component of the radiation imaging apparatus.

10. The radiation imaging apparatus according to claim 1, wherein the component has a plurality of constituent parts for constituting the component.

11. The radiation imaging apparatus according to claim 1, wherein the component includes at least one selected from the group of copper and iron.

12. The radiation imaging apparatus according to claim 1, wherein the attenuation member continuously changes in thickness at an end portion of an outer shape.

13. The radiation imaging apparatus according to claim 1, wherein the attenuation member is detachably attached to the radiation imaging apparatus.

14. The radiation imaging apparatus according to claim 1, wherein the attenuation member includes at least one selected from the group of tungsten, molybdenum, lead, stainless used steel (SUS), iron, bismuth, and cerium.

15. The radiation imaging apparatus according to claim 1, comprising a housing that contains the radiation detection unit and the component,
wherein a plane of the housing opposite to a plane on which the radiation is incident is made of carbon fiber reinforced plastic (CFRP).

16. The radiation imaging apparatus according to claim 1, wherein each of the plurality of pixels has a photoelectric conversion element, and the radiation detection unit has a scintillator that converts the radiation into light sensible by the photoelectric conversion element.

17. A radiographing system comprising:
a radiation imaging apparatus that performs radiographic imaging based on radiation having been emitted by a radiation generation apparatus and passed through a subject, comprising:
a radiation detection unit that includes a plurality of pixels for converting the radiation into an electrical signal and has a first plane on a side of the radiation detection unit which the radiation from the radiation generation apparatus is incident and a second plane on a side opposite to the first plane;
a component that is provided on the second plane of the radiation detection unit; and
an attenuation member that is provided on the second plane of the radiation detection unit to attenuate back scattered radiation incident on the radiation detection unit from the side of the second plane,
wherein the attenuation member is made of a material with a higher atomic number and a material with a lower atomic number than a material with a highest atomic number among materials of the component, covers an end portion of an outer shape of the component overlapping the radiation detection unit in orthogonal projection onto the second plane, and is smaller in area than the radiation detection unit; and
an image processing unit configured to process radiation detected by the radiation imaging apparatus as a radiographic image.
